(19) United States
(12) Patent Application Publication
(10) Pub. No.: US 2011/0133930 A1
(43) Pub. Date: Jun. 9, 2011

(54) FILTERING VIDEO EVENTS IN A SECURED AREA USING LOOSE COUPLING WITHIN A SECURITY SYSTEM

(75) Inventor: William R. Blum, Huntington, NY (US)

(73) Assignee: Honeywell International Inc., Morristown, NJ (US)

(21) Appl. No.: 12/633,997

(22) Filed: Dec. 9, 2009

(51) Int. Cl. G08B 13/08; G08B 13/00

(52) U.S. Cl. 340/545.2; 340/541; 348/152; 340/5.6

(57) ABSTRACT

A method and apparatus for detecting events in a security system. The method includes the steps of providing a secured area having a plurality of physical sensors that detect events associated with the secured area and a plurality of video devices that each collect video images of the secured area and detect motion within the collected images, a database storing events associated with activated sensors and video sequences associated with detected motion and an event processor associating activation of a predetermined sensor of the plurality of sensors with detected motion from a predetermined video device of the plurality of video devices and storing the associated video sequence and identifier of the activated sensor in a log file.

### FIELD OF THE INVENTION

The invention is related to security systems and more particularly to the recording of events within a security system.

### BACKGROUND OF THE INVENTION

Security systems are generally known. Such systems are typically used by a person or organization to protect assets or people within a secured area.

Security systems typically include a physical barrier (e.g., a fence, wall, etc.) to exclude unauthorized persons. Distributed along the physical barrier may be a number of potential access points (e.g., doors, windows, etc.) that can be used for access by authorized persons.

In order to detect intruders, the access points may be monitored by one or more perimeter switches. The switches are monitored by an alarm panel. Many of the access points may be provided with an identification reader to detect entry or egress by authorized persons.

In addition to perimeter switches, many security systems also include video cameras that monitor the secured area and/or the periphery of the secured area. Many of the video cameras are capable of detecting motion and can be programmed to send an intruder alarm to the alarm panel for confirmation by a human guard upon detection of motion.

While video cameras that detect motion work well, they are often subject to false alarms. Within the secured area, the video camera cannot differentiate between authorized and unauthorized persons. Small animals, such as pets within a secured area, may trigger alarms. Wind through an open window may cause curtains to flutter and trigger an alarm. Lightning at night can cause sufficient contrast to trigger an alarm. Because of the importance of security systems and motion detection by video system, a need exists for better methods of using motion detection in video cameras.

### BRIEF DESCRIPTION OF THE DRAWINGS

FIG. 1 is a block diagram of a security system in accordance with an illustrated embodiment of the invention.

### DETAILED DESCRIPTION OF AN ILLUSTRATED EMBODIMENT

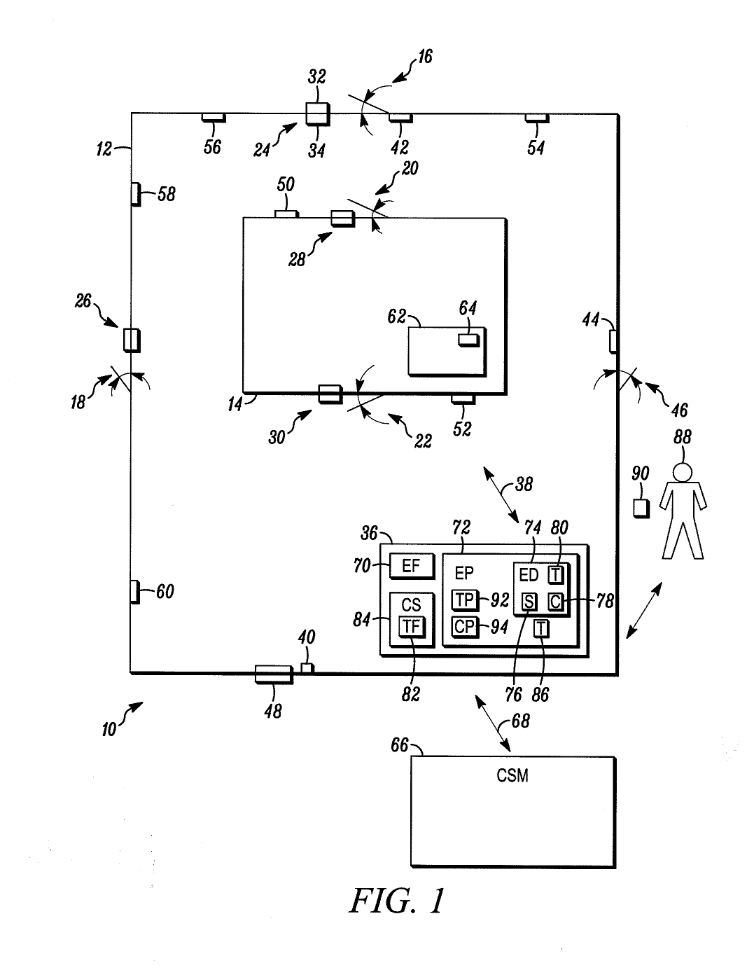

FIG. 1 is a block diagram of a security system 10 that protects a secured area 12 under an illustrated embodiment of the invention. The secured area 12 may include one or more inner secured areas 14 where the inner secured area 14 has a higher relative security level than the outer security area 12.

Included within the secured area 12 may be a number of access points 16, 18, 20, 22 (e.g. doors). Associated with each of the access points 16, 18, 20, 22 may be an access controller 24, 26, 28, 30. The access controllers 24, 26, 28, 30 may each include at least one identification reader (e.g., a card reader, keypad, fingerprint or iris scanner, etc.) 32 and an electrically activated lock that enables entry through the access point 16, 18, 20, 22. Where the access controller 24, 26, 28, 30 includes only a single card reader 32, the reader 32 may be placed outside the secured area thereby requiring an authorized person to activate the entry reader 32 using an identification card (keycard) before entry is allowed into the respective secure area 12, 14. Alternatively, each security area 12, 14 may be provided with an entry reader 32 for entering a respective security area 12, 14 and an egress reader 34 for exiting the respective security area 12, 14.

The access controllers 24, 26, 28, 30 may each be connected to and controlled by an alarm panel 36. The connection links 38 between the alarm panel 36 and access controllers 24, 26, 28, 30 may be provided in the form of electrical conductors or via a wireless connection.

In each case, when an authorized user swipes an access card through an entry or egress reader 32, 34, the reader 32, 34 reads the user identification and sends the identification to the alarm panel 36. The alarm panel 36 compares the received identification with a content of a respective file for each authorized user and grants access or denies access based upon matching the received content with the file content. If the alarm panel 36 grants access, then the alarm panel 36 opens the lock on the access point allowing access into the secure area 12, 14 by the authorized user.

Security sensors within the areas 12, 14 may also include a respective door sensor 42 on each of the access points 16, 18, 20, 22, doors sensors 44 on any emergency exit doors 46 and window sensors 40 on any windows 40. The areas 12, 14 may also include security sensors 64 on any high value assets 62 (e.g., a safe). The sensors 40, 42, 44, 64 are each also connected to the alarm panel 36 via respective connection links 38.

Under normal conditions, activation of any of the door or window switches 40, 44 would generate an alarm. Similarly the opening of a door of an access point 16, 18, 20, 22 (by force or otherwise) without detection of a card swiped through a reader 32, 34 would also generate an alarm.

The area 12 may also include one or more motion sensors 50, 52 and video cameras 54, 56, 58, 60. The motion sensors 50, 52 may operate via an infrared format. The video cameras, in turn, may be IP cameras that have the capability of detecting movement by comparing successive frames for differences. As with the access controllers and door and window switches, the motion sensors 50, 52 and cameras 54, 56, 58, 60 may be connected to the alarm panel 36 via the connection link 38.

The alarm panel 36 may have a number of different operating modes. In an all-secure mode (no person(s) present within areas 12, 14), the activation of any sensor that directly detects physical activity, such as by a security switch 40, 42, 44, 64 or by a motion detector 50, 52, causes the alarm panel 36 to generate an alarm. Similarly, the detection of movement through a video camera 54, 56, 58, 60 may also cause the alarm panel 36 to generate an alarm. In this case, the alarm panel 36 monitors an output of each of the physical sensors 40, 42, 44, 64, 50, 52 and may also monitor a detected motion output of the cameras 54, 56, 58, 60 for a signal (e.g., contact closure, digital message, etc.) indicating an intruder. The alarm panel 36, in turn, composes an alarm notification message.

Generation of the alarm in the case may mean that the security panel 36 sends an alarm notification message to a central monitoring station 66 through a communication link 68. As above, the communication link 68 may be a wireline connection through the public switch telephone system (PSTN) or may be wireless. If the link 68 is wireless, then the alarm panel 36 may include a cellular transceiver that transmits an alarm notification message to a local base station of the cellular system, where the cellular system, in turn, transfers the alarm to the central station 66 either via the PSTN or the Internet.

When one or more persons are present within the areas 12, 14, the alarm panel 36 may operate at a second, lower level of security. In this case, the transition to the lower level of security may be triggered by an authorized person entering a code through a keypad or by the authorized person swiping a card through an access request reader 32. Under this mode, the alarm panel 36 may only generate an alarm notification message in the case where a perimeter sensor 40, 42, 46 is activated and the activation is not associated with the use of a keycard by an authorized person through an access point 16, 18, 20, 22.

During the normal course of operation, the alarm panel 36 may continuously monitor the perimeter sensors 40, 42, 46, the access readers 32, 34, the motion detectors 50, 52 and video cameras 54, 56, 58, 60 for detected events. Detected events may be stored in an event log file 70 within a memory of the alarm panel 36. Event messages saved in the file 70 for the physical sensors 40, 42, 44, 50, 52, 64 may simply include an identifier of the sensor and a time of activation. In the case of the video cameras 54, 56, 58, 60, the detection of motion a the video cameras 54, 56, 58, 60 also causes a sequence of video frames to be saved along with the identifier of the camera 54, 56, 58, 60 and the time of detection.

The generation of alarm notification messages to the central station 66 may be accomplished based upon a set of current events and the alarm mode. In the lower level of security, the events associated with the motion sensors 50, 52 and video camera 54, 56, 58, 60 may be ignored because the outputs associated with these devices may be caused by authorized persons in the normal course of activity.

Under an illustrated embodiment of the invention, an event recording system including an event processor 72 within the alarm panel 36 may monitor a current set of entries in the event file 70 for purposes of identifying one or more predetermined combinations of events. The identification of predetermined combinations of events occurs completely separate from the process of detecting alarms. The detected combinations of events in many cases, in fact, would not generate an alarm from the alarm panel 36.

Each combination of events is defined by an event definition file 74 within the event processor 72. The event definition file 74 includes an identifier 76 of a physical sensor 40, 42, 44, 50, 52, 64, the identifier 78 of a camera 54, 56, 58, 60 and a time value 80.

In effect, the event processor 72 continuously searches the event file 70 for the identifier 76 of a physical sensor and the identifier 78 of a camera. The identifier 76 of a sensor in the event log file 70 indicates activation of the identified sensor and the identifier 78 of the camera indicates the detection of motion within a series of video frames of the identified camera. When the identifier 76 of the sensor and identifier 78 of the camera occur within a period of time less than the time value 80, a sequence of images from the camera, the identifiers 76, 78 and the current time are saved to a tracking file 82 within a central server 84. The server 84 may be located within the alarm panel 36 (as shown in FIG. 1) or within the central monitoring station 66.

The event definition files 74 may be created by a person 88 who administrates the use of the alarm system 10 through a terminal 86 attached to the alarm panel 36 or through a browser of a portable device 90 carried by the person 88. As each definition file 74 is created, it is saved to the event processor 72. Any combination of physical sensors 40, 42, 44, 50, 52, 64 and cameras 54, 56, 58, 60 can be associated (logically ANDed together) so that activation of both devices within some time interval causes a video sequence to be saved.

For example, the person 88 may want to see who goes in and out a certain exit (e.g., access point 16). In this case, the person may save the identifier 76 of the sensor 42, the identifier 78 of camera 54 in the definition file 74 and an appropriate time interval (e.g., 30 seconds) as the time value 80.

Each time a person opens the door of the access point 16, the sensor 42 is activated. Similarly, the video camera 54 continuously collects video images of the region of the access point 16 and would detect movement of the person passing through the access point 16. The events detected by the sensor 42 and video camera 54 are independent send to the alarm panel 36 and recorded in the event file 70 as separate event messages.

Once recorded in the event file 70, the event processor 72 detects the two events and determines that they meet at least two of the requirements of the definition file 74. The event processor 72 then compares the time stamp of each event record to determine if the two events occurred during a time interval that is less then the time period 78. If so, then the event is saved to the tracking file 82.

Also present within the event processor 72 may be a tracking processor 92. The tracking processor 92 may monitor the tracking file 82 and notify the person 88 of any new entries. Once notified, the user 88 may retrieve the tracking file 82 from the server 84 using the handheld device 90.

As another example, an authorized person may be walking past the camera 54. The camera 54 may detect movement of the person and send to the event file 70 as an event message.

In this case, the event processor 72 may detect the event message from the camera 54, but not an event message from the sensor 42. In this case, the event would not be reported.

In another embodiment, the event definition file 74 could be expanded to include the use of the card readers 32, 34. In this case, the identifier 76 of the sensor would be replaced or used in conjunction with the identifier of the reader 32, 34 or the identifier of a particular authorized person. In this case, whenever the authorized user swipes a keycard through the card reader 32, 34 a nearby camera 54, 56, 58 60 would be activated to monitor the activity of the person without alerting the person to the activity. Such action could have great value in the case of suspected employee theft.

In general, the described method and apparatus for detecting events has an almost unlimited flexibility. The event recording system involves tying triggers from physical sensors or other events with collected video clips from cameras at the central server. Camera placed within the secured area use their motion detection capabilites to trigger the capture of potentially valuable video events. These events are then forwarded to the central server and stored. In addition, the security system which is driven by sensors, such as motion detectors, (indoor or outdoor) switches on windows and doors, asset protection sensor and others and status changes like arm/disarm cause these events to be sent to the central server. The central server can be programmed by the end user to relate security system events to a given camera. The central server then reconciles video and security system events according to the user's selection and only send the desired video clip to the end user, or retain them in the history log.

A specific embodiment of method and apparatus for detecting predetermined activities in a security system has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method comprising:
providing a secured area having a plurality of physical sensors that detect events associated with the secured area and a plurality of video devices that each collect video images of the secured area and detect motion within the collected images;
a database storing events associated with activated sensors and video sequences associated with detected motion; and
an event processor associating activation of a predetermined sensor of the plurality of sensors with detected motion from a predetermined video device of the plurality of video devices and storing the associated video sequence and identifier of the activated sensor in a log file.

2. The method as in claim 1 wherein the predetermined sensor further comprises a card reader.

3. The method as in claim 1 wherein the predetermined sensor further comprises a motion sensor.

4. The method as in claim 1 wherein the predetermined sensor further comprises a door or window switch.

5. The method of claim 1 wherein the association further comprises a time delay between activation of the predetermined sensor and detected motion within the video of the predetermined video device.

6. The method as in claim 1 further comprising sending the associated sequence of images to a requesting person.

7. The method as in claim 6 further comprising the requesting person identifying the predetermined sensor and video device to the event processor.

8. The method as in claim 7 further comprising the requesting person defining a time period for associating the detected motion of the video device with the predetermined sensor.

9. A system comprising:
a secured area;
a plurality of physical sensors within the secured area that detect events associated with the secured area and a plurality of video devices that each collect video images of the secured area and detect motion within the collected images;
a database that stores events associated with activated sensors and video sequences associated with detected motion; and
an event processor that associates activation of a predetermined sensor of the plurality of sensors with detected motion from a predetermined video device of the plurality of video devices and storing the associated video sequence and identifier of the activated sensor in a log file.

10. The apparatus as in claim 9 wherein the predetermined sensor further comprises a card reader.

11. The apparatus as in claim 9 wherein the predetermined sensor further comprises a motion sensor.

12. The apparatus as in claim 9 wherein the predetermined sensor further comprises a door or window switch.

13. The apparatus of claim 9 wherein the association further comprises a time delay between activation of the predetermined sensor and detected motion within the video of the predetermined video device.

14. The apparatus as in claim 9 further comprising sending the associated sequence of images to a requesting person.

15. The apparatus as in claim 14 further comprising the requesting person identifying the predetermined sensor and video device to the event processor.

16. The apparatus as in claim 15 further comprising the requesting person defining a time period for associating the detected motion of the video device with the predetermined sensor.

17. An apparatus comprising:
a secured area having a plurality of physical sensors that detect events associated with the secured area and a plurality of video devices that each collect video images of the secured area and detect motion within the collected images;
means for storing events associated with activated sensors and video sequences associated with detected motion; and
means for associating activation of a predetermined sensor of the plurality of sensors with detected motion from a predetermined video device of the plurality of video devices and storing the associated video sequence and identifier of the activated sensor in a log file.

18. The apparatus as in claim 17 wherein the predetermined sensor further comprises a card reader.

19. The apparatus as in claim 17 wherein the predetermined sensor further comprises a motion sensor.

20. The apparatus as in claim 17 wherein the predetermined sensor further comprises a door or window switch.
